(19) United States
(12) Patent Application Publication
(10) Pub. No.: US 2006/0247354 A1
(43) Pub. Date: Nov. 2, 2006

(54) Method of manufacturing nanoscale metal oxide particles

(76) Inventors: Ping He, Wu Han (CN); Hang Jin, Richmond (CA)

Correspondence Address: BRINKS HOFER GILSON & LIONE, P.O. BOX 10395, CHICAGO, IL, 60610, US

(21) Appl. No.: 11/226,727

(22) Filed: Sep. 14, 2005

(30) Foreign Application Priority Data
Dec. 15, 2004 (CN) 200410061353.9

(51) Int. Cl. C08K 3/22

(52) U.S. Cl. 524/430

(57) ABSTRACT

A new method of manufacturing nanoscale single- and multi-component metal oxide particles is described. In a first step of the method, a first solution that includes one or more metal salts, an acid, and a solvent is formed; in a second step, a second solution that includes an organic polymer, a base, and water is formed; in a third step, the first solution is combined with the second solution to form a combined solution, and a precipitation reaction occurs such that metal hydroxide particles precipitate out of the combined solution; in a fourth step, the metal hydroxide particles are collected, rinsed, and dried; and finally, in a fifth step, the metal hydroxide particles are heated, thereby forming nanoscale metal oxide particles of less than about 100 nm in size. Exemplary nanoscale particles that may be produced using this method include indium tin-oxide (ITO) and antimony doped-tin oxide (ATO).

### RELATED APPLICATIONS

This application claims the benefit of priority to Chinese Patent Application no. 200410061353.9, filed Dec. 15, 2004, and which is incorporated herein by reference.

### TECHNICAL FIELD

The present application relates to the field of nanoparticle manufacturing. More particularly, the present application relates to a method of manufacture of metal oxide nanoparticles.

### BACKGROUND

Nanoscale metal oxide particles that behave as semiconductors have a variety of commercial applications. Such nanoscale particles may be used, for example, to form transparent conductive coatings that prevent static electricity and dust accumulation and also absorb infrared and ultraviolet radiation. Transparent conductive coatings find application in personal computers, liquid crystal displays, solar cells, automotive and building glass, packaging materials for integrated circuits, and interior surfaces of industrial clean rooms, for example. The nanoscale particles may be incorporated into coating formulations and applied to substrates directly, or consolidated into sputtering targets, which are used as raw materials for the deposition of various types of films. Due to rising demand for transparent conductive coatings in a number of applications, the tonnage requirements for nanoscale particles suitable for producing these coatings is expected to correspondingly increase over the next decade.

A number of approaches have been set forth in the literature to manufacture nanoscale metal oxide particles and, in particular, nanoscale metal oxide particles containing more than one metallic species, such as indium-tin oxide or antimony doped-tin oxide nanoparticles. These approaches include both vapor phase and liquid phase techniques. A conventional liquid phase method to produce nanoscale multi-component metal oxide particles begins with the preparation of a solution that contains the metal ions of the desired nanoscale particles. The metal ions react with an alkaline water solution, thereby forming hydroxide precipitates. The precipitates are rinsed to eliminate impurities, followed by drying and heating at 600° C.-850° C. in order to obtain nanoscale multi-component metal oxide powders. The conventional method has several shortcomings, however, including:

(a) Extensive usage of inorganic acid. The disposal and treatment of waste liquids generated in the conventional liquid phase method may contribute to contamination of the environment and also raise manufacturing costs.

(b) The manufacturing of small particles, and nanoscale particles in particular, is completed in low yields. Due to this low production efficiency, investment in additional capital equipment may be required to keep up with demand for the nanoscale particle product.

(c) The hydrolyses of two metal ions together in the conventional process results in a large variance in pH that prevents co-precipitation in whole or in part from occurring. This in turn results in nonuniformity on a micro- and/or nanoscale that may detrimentally affect the quality of products fabricated from the nanoparticles.

(d) The precipitated hydroxides are prone to agglomeration (clumping). As a result, they must be mechanically milled (e.g., ball milled) in order to break up the agglomerates prior to high temperature sintering (heating). This adds an additional manufacturing step and may introduce undesirable impurities.

(e) Because co-precipitation cannot be achieved with the conventional method, the sintering temperature required for conversion of the hydroxide particles to oxide particles is very high. This adds to the manufacturing costs.

Due to these shortcomings, an improved method of manufacturing nanoscale metal oxide particles, including single-component and multi-component metal oxide particles, is needed.

### SUMMARY

A new method of manufacturing nanoscale metal oxide particles, wherein single- or multi-component metal oxide particles are formed, is described. The method may overcome the limitations and disadvantages of conventional methods and enable the environmentally-friendly production of metal oxide particles in higher volumes and at lower manufacturing costs than is possible with current methods.

Accordingly, in a preferred embodiment, the present method is directed at a manufacturing method for nanoscale particles that entails the following steps: in a first step, a first solution that includes one or more metal salts, an acid, and a solvent is formed; in a second step, a second solution that includes an organic polymer, a base, and water is formed; in a third step, the first solution is combined with the second solution to form a combined solution, and a precipitation reaction occurs such that metal hydroxide particles precipitate out of the combined solution; in a fourth step, the metal hydroxide particles are collected, rinsed, and dried; and finally, in a fifth step, the metal hydroxide particles are heated, or sintered, thereby forming nanoscale metal oxide particles.

In another preferred embodiment, the present method is directed at a manufacturing method for nanoscale particles that entails the following steps: in a first step, a first solution that includes two or more metal salts, an acid, and a solvent is formed; in a second step, a second solution that includes an organic polymer, a base, and water is formed; in a third step, the first solution is combined with the second solution to form a combined solution, and a precipitation reaction occurs such that metal hydroxide particles precipitate out of the combined solution; in a fourth step, the metal hydroxide particles are collected, rinsed, and dried; and finally, in a fifth step, the metal hydroxide particles are heated, or sintered, thereby forming nanoscale metal oxide particles.

In another preferred embodiment, the present method is directed at a manufacturing method for nanoscale particles that entails the following steps: in a first step, a first solution that includes two or more metal salts, ethylene acid, and a solvent is formed; in a second step, a second solution that includes a polyethylene ethanol, a base, and water is formed; in a third step, the first solution is combined with the second solution to form a combined solution, and a precipitation reaction occurs such that metal hydroxide particles precipitate out of the combined solution; in a fourth step, the metal hydroxide particles are collected, rinsed, and dried; and finally, in a fifth step, the metal hydroxide particles are heated or sintered at about 500° C. for about 5 hours, thereby forming nanoscale metal oxide particles.

These and other features, aspects, and advantages of the present invention will become better understood with regard to the following detailed description, appended claims and accompanying drawing.

### BRIEF DESCRIPTION OF THE DRAWINGS

FIG. 1 illustrates the steps of the method according to an embodiment of the invention.

### DEFINITIONS

The term “single-component metal oxide” is used herein in reference to a metal oxide based on a single metal species. The term “multi-component metal oxide” is used herein in reference to a metal oxide based on two or more metal species.

The term “nanoscale particles” is used interchangeably in this application with the terms “nanoparticles,” “nanopowder” and “nanopowders.” These terms are understood in the art to refer to a plurality of discrete particles or crystals, each of which is approximately 100 nanometers (nm) or less in size.

### DETAILED DESCRIPTION

A new method of manufacturing nanoscale metal oxide particles, wherein single- or multi-component metal oxide particles are formed, is described. The method may overcome the limitations and disadvantages of conventional methods and enable the environmentally-friendly production of metal oxide particles in higher volumes and at lower manufacturing costs than is possible with current methods.

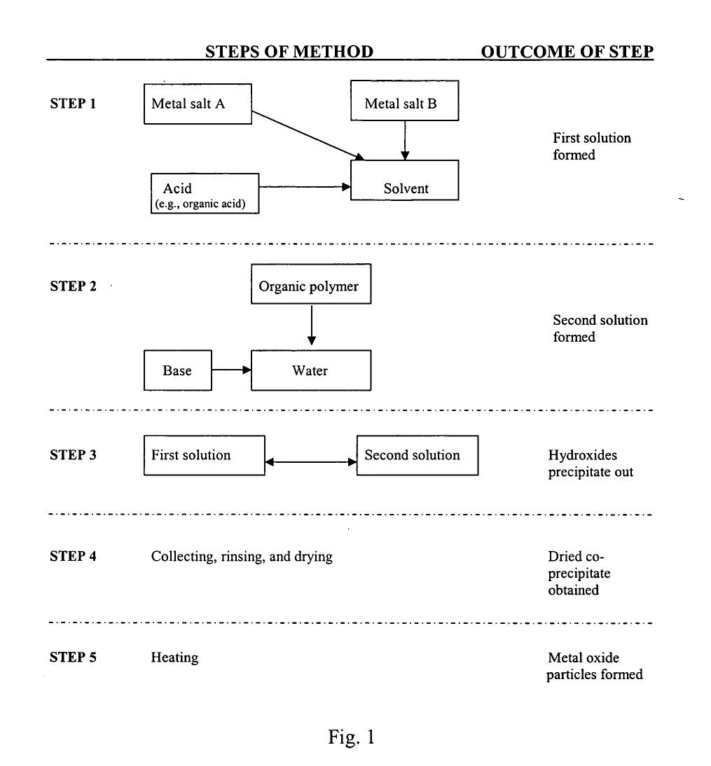

Referring to FIG. 1, the present method includes the following steps according to one embodiment: In the first step, a first solution is formed that includes one or more suitable metal salts (e.g., Metal salt A and Metal salt B, chosen such that the one or more metal salts contain the metal species desired in the nanopowder product), a suitable acid, wherein a suitable acid will allow a pH of no greater than 6 to be maintained in the combined solution described below, and a suitable solvent, wherein a suitable solvent may readily dissolve one or more metal salts. The second step involves forming a second solution that includes a suitable organic polymer, wherein the suitable organic polymer may provide electrosteric stabilization for either hydroxide particles or oxide particles, a suitable base, such as one having a pH of greater than 7 in which there is enough alkali to keep one or more metal salts hydrolyzed, and water. In the third step, the first solution and the second solution are combined to form a combined solution, whereupon metal hydroxide particles precipitate out of the combined solution. Subsequent steps center on collecting, rinsing, and drying the metal hydroxide particles using standard methods well-known in the art. Last, the metal hydroxide particles are heated to a degree that nanoscale metal oxide particles are formed.

The selection of the one or more suitable metal salts employed in the first step of the present method determines the metal species present in the final metal oxide particle product. Preferably, the one or more suitable metal salts used in the first step each include a metal ion selected from the group consisting of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, and Dy ions. For example, a metal salt included in the first solution may include an ion of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, or Dy. More preferably, the one or more suitable metal salts used in the first step of the present method each include a metal ion selected from the group consisting of Al, In, Sb, Sn, and Zn ions. That is, each metal salt may include an ion of Al, In, Sb, Sn or Zn. In a preferred embodiment, one metal salt is included in the first solution.

Any number of different metal salts may be employed in the context of the present method. In another preferred embodiment, the first step of the inventive method is carried out using two or more different metal salts, such as, for example, from about two to about eight. More preferably, from about two to about four metal salts are employed in the present method. Most preferably, two different metal salts are utilized in the first step of the present method. Preferably, the two or more different metal salts each include a metal ion selected from the group consisting of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, and Dy ions. In other words, the two or more different metal salts each include an ion of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, or Dy. More preferably, the two or more different metal salts employed in the first step each include a metal ion selected from the group consisting of Al, In, Sb, Sn, and Zn ions. That is, the two or more different metal salts each include an ion of Al, In, Sb, Sn or Zn.

In a particularly preferred embodiment, when two different metal salts are utilized in the first step of the present method, one of the two different metal salts includes an In ion, and the other metal salt includes an Sn ion. In another particularly preferred embodiment, when two different metal salts are utilized in first step of the present method, one of the two different metal salts includes an In ion, and the other includes an Sb ion. In another particularly preferred embodiment, when two different metal salts are utilized in the first step of the present method, one of the two different metal salts includes an Al ion, and the other includes a Zn ion.

Any number of different acids may be used in the context of the present method. Preferably, the acid used in the first step of the present method is an organic acid. Preferred organic acids include an organic compound linked to an acid moiety. Examples of useful acid moieties include, without limitation, carboxylic, dicarboxylic, thiocarboxylic, imidic, sulfonic, sulfinic, and selenonic acids. Preferably, the acid moiety is a carboxylic acid. The carboxylic acid used herein is most preferably selected from the group consisting of acrylic acid, methacrylic acid, formic acid, acetic acid, salicylic acid, citric acid, or oxalic acid.

In one embodiment, the organic acid includes a monomer linked to the acid moiety. The monomer can be any organic compound that includes suitable reactive groups for linking to an acid. Examples of monomers that may be usefully employed include, without limitation, those represented by the chemical formula CₙH₂ₙ, where n is an integer in the range of from 1 to 10, inclusive. Preferably, the monomer is ethylene. In one embodiment, the organic acid is ethylene acid. Ethylene acid may be obtained from various manufacturers, including, for example, E.I. Du Pont de Nemours and Co. (Wilmington, Del.), which sells ethylene acid under the registered trademark Nucrel®.

The solvent employed in the first step to form the first solution is preferably an organic solvent. Examples of organic solvents that may be used include, without limitation, isopropyl alcohol, ethyl alcohol, and methyl alcohol. In a preferred embodiment, isopropyl alcohol is used.

Preferably, the organic polymer used in the second step to form the second solution is a vinyl polymer. A vinyl polymer that may be used is polyethylene ethanol, polyvinyl alcohol (PVA), polyvinylpyrrolidinone (PVP), polyvinyl ether (PVE), or N-isopropylacrylamide (PNIPAAm). In a preferred embodiment, the organic polymer is polyethylene ethanol. Polyethylene ethanol may be obtained from, for example, Hubei Province Chibi City Organic Chemicals Factory (Chibi, Hubei Province, China).

Preferably, the base used in the second step of the present method is a hydroxide of a Group IA or a Group IIA metal. Examples of Group IA or Group IIA metals that are useful in the context of the present method include, without limitation, Na, K, Li, Rb, Cs, Ca, Sr, and Ba. In a preferred embodiment, the base used in the second step of the present method is a hydroxide of Na, that is, NaOH. Preferably, the water used in the second step is deionized water.

In the third step of the present method, the first solution is combined with the second solution to form a combined solution, whereupon metal hydroxide particles precipitate out of the combined solution. Preferably, the combined solution is maintained at a temperature above ambient, for example, at a temperature in the range of from about 35° C. to about 50° C., until the precipitation reaction is complete. In one embodiment, wherein a single metal salt species is included in the first step, a single type of metal hydroxide particle precipitates out of the combined solution. In another embodiment, wherein two or more different metal salts are included in the first step, two or more different types of metal hydroxide particles precipitate out of the combined solution.

Each metal hydroxide particle is several nanometers or more in size and suspended in the combined solution (suspension). Substantial clumping or agglomeration of like species of metal hydroxide particles is avoided, in contrast to the conventional method, and therefore the intermingling or mixing of different types of metal hydroxide particles is improved. Accordingly, different types of metal hydroxide particles may more readily come into contact with each other in the suspension in the present method, allowing for effective doping of the molecules.

To provide a plausible theoretical basis for understanding the successful result of the present invention in the improved intermingling of different types of metal hydroxide particles, it is hypothesized that the uniform intermingling of the different metal hydroxide particles is facilitated by the formation of an organic complex of metal ions in the first solution that allows for simultaneous hydrolyses of different metal ions at the same pH. Irrespective of what mechanism in fact turns out to be the case, this disclosure teaches a method that allows, in contrast to the conventional method, a uniform pH of the solution in which the hydrolyses of different metal ions occur. With improved intermingling of the different types of metal hydroxide particles in the present method, the final heating step may be carried out at a lower temperature than is required in the conventional method, preferably about 250° C. to 450° C. lower. Furthermore, because the hydroxide particles are not extensively agglomerated, as is typical of the hydroxide particles produced by the conventional method, a mechanical milling step (e.g., ball milling) is not required prior to the heating step. The absence of a milling step and the lower heating temperature used in the fifth step of the present method contribute to a lower manufacturing cost compared to the conventional method.

In the fourth step of the method, the metal hydroxide particles are collected from the combined solution. In a preferred embodiment, the step of collecting the particles includes a filtration process. The collected particles are then rinsed and dried, using standard methods well-known in the art. Preferably, the drying is carried out at a temperature above ambient, for example, at a temperature in excess of about 35° C.; more preferably, at a temperature in the range of from about 35° C. to about 55° C. Yet more preferably, the drying is carried out at a temperature of from about 40° C. to about 50° C.; most preferably, from about 43° C. to about 47° C.

In the fifth step of the method, the metal hydroxide particles are heated, or sintered, such that the metal hydroxide particles are transformed into metal oxide particles. As discussed above, the temperature at which the heating step is carried out is at least about 400° C. and can be as high as in the conventional method (e.g., about 600° C. to 850° C.). A favorable aspect of the present method is that the heating can be accomplished successfully at a significantly lower temperature than in the conventional method. The heating step of the present method is generally carried out at a temperature which is from about 200° C. to 450° C. lower than the temperature used in the heating step of the conventional method. Preferably, the heating step of the present method is carried out at a temperature in the range of from about 400° C. to about 600° C. More preferably, the heating step is carried out at a temperature in the range of from about 450° C. to about 550° C. In one preferred embodiment, the heating step is carried out at a temperature of from about 475° C. to about 525° C. Further, the heating step is preferably carried out for a duration in the range of from about 4 hours to about 6 hours. More preferably, the heating step is carried out for a duration in the range of from about 4.5 to about 5.5 hours. In one preferred embodiment, the heating step is carried out for a duration of from about 4.75 hours and about 5.25 hours.

In one embodiment, wherein a single metal salt species is used in the first step of the present method, the metal oxide particles formed in the fifth step of the method are single-component metal oxide particles composed of a single metallic element. The metallic element may be In, Sn, Sb, Zn, Al, Ti, Zr, V, Nb, Cr, Mo, Mn, Fe, Co, Ni, Cu, Ag, Zn, Cd, Ga, Si, Ge, Pb, Bi, As, Se, Y, Eu, or Dy. Preferably, the metallic element is selected from the group consisting of In, Sn, Sb, Zn and Al; that is, the metallic element may be In, Sn, Sb, Zn, or Al. Exemplary single-component metal oxide particles that may be produced by the present method include, without limitation, In₂O₃, SnO₂, Sb₂O₃, ZnO, Al₂O₃, TiO₂, Y₂O₃, and ZrO₂, any one of which may be successfully produced using the present invention.

In a another embodiment, wherein two or more different metal salts are used in the first step of the present method, the resultant metal oxide particles are multi-component metal oxide particles composed of two or more different metallic elements. The two or more different metallic elements are selected from the group consisting of In, Sn, Sb, Zn, Al, Ti, Zr, V, Nb, Cr, Mo, Mn, Fe, Co, Ni, Cu, Ag, Zn, Cd, Ga, Si, Ge, Pb, Bi, As, Se, Y, Eu, and Dy. That is, each of the two or more different metallic elements may be In, Sn, Sb, Zn, Al, Ti, Zr, V, Nb, Cr, Mo, Mn, Fe, Co, Ni, Cu, Ag, Zn, Cd, Ga, Si, Ge, Pb, Bi, As, Se, Y, Eu, or Dy. Preferably, the two or more different metallic elements are selected from the group consisting of In, Sn, Sb, Zn and Al. That is, preferably, each of the two or more different metallic elements may be In, Sn, Sb, Zn or Al.

In a preferred embodiment, the metal oxide particles are multi-component metal oxide particles composed of two different metallic elements. In one particularly preferred embodiment, the two different metallic elements are In and Sn. In another preferred embodiment, the two different metallic elements are Sn and Sb. In yet another preferred embodiment, the two different metallic elements are Al and Zn. Exemplary multi-component metal oxide particles produced according to a particularly preferred embodiment of the present method include indium-tin oxide (ITO), antimony-doped tin oxide (ATO), and aluminum-zinc oxide (AZO).

The metal oxide particles produced using the inventive method are substantially nonagglomerated and characterized by a uniform particle size distribution, wherein the particle size may be controlled to within about 50%. Preferably, the metal oxide particles are about 100 nm or less in size. More preferably, the metal oxide particles are about 50 nm or less in size. Even more preferably, the metal oxide particles are less than about 10 nm in size. Generally, the metal oxide particles have a lower size limit of between about 3 nm and 7 nm; more particularly, about 3 nm, about 4 nm, about 5 nm, about 6 nm, or about 7 nm. In one preferred embodiment, the metal oxide particles range in size from about 5 nm to about 10 nm.

The nanoscale particles of the present invention are obtained at a yield of about 20% by weight of the starting materials. This yield represents an approximately four-fold improvement compared to the conventional method. It is hypothesized that the use of an organic polymer in the precipitation reaction enables the production of uniform, nanoscale particles at relatively high yields by controlling the scope of the precipitation reaction.

The following examples illustrate the present invention, a method for manufacturing nanoscale particles, as well as, for comparison, a conventional method. These examples are provided for the purpose of clarifying the invention and terms used in describing same. The examples should not be viewed as limiting the invention as described hereinabove, particularly in view of the ability for a skilled artisan to use differing standard techniques known in the art, some of which are set forth or alluded to here to implement the present invention.

In summary, the examples set forth below demonstrate that the nanoscale metal oxide powders of the present method are characterized by a smaller particle size, a more uniform particle size distribution, better dispersion stability, and higher electrical conductivity in consolidated form than nanoscale metal oxide particles produced by a conventional method. Furthermore, the examples show that the nanoscale particles of the inventive method can be used to form sputtering targets, which serve as raw materials for the deposition of transparent conductive and other types of films, or they may be formulated into liquid dispersions and coated directly onto substrates of interest, thereby forming transparent conductive and other types of films.

### EXAMPLE 1

This example sets forth a method for manufacturing nanoscale antimony-doped tin oxide (ATO) particles according to the present invention, and further compares the same to nanoscale ATO particles prepared by a conventional method, which is also set forth below. In particular, the characteristics and properties, including particle size and particle size distribution, electrical conductivity and dispersibility, of the ATO nanopowders are compared in the following.

In a process corresponding to the inventive manufacturing method, 120 g of SnCl₄.5H₂O and 12 g of SbCl₃ were measured and dissolved into 200 ml of isopropyl alcohol, and then 1 g of ethylene acid was added to prepare a reactant liquid. 100 ml of de-ionized water was used to dilute 3 g of polyethylene ethanol to form a water solution, and NaOH was used to maintain the pH of the water solution at pH=4. The reactant liquid was dropped into the water solution at 45° C., and a co-precipitate of Sn(OH)₄ and Sb(OH)₃ was obtained through a hydrolytic reaction. The co-precipitate was filtered, rinsed, and then dried at a constant temperature of 120° C. for 8 h, followed by sintering at 500° C. for 5 h. The resultant ATO nanopowder was 5-10 nm in size and will hereinafter be referred to as Al.

In a process corresponding to a conventional manufacturing method, 120 g of SnCl₄.5H₂O, 12 g of SbCl₃ and concentrated HCl were dissolved together into 200 ml of de-ionized water to make a reactant liquid. 50 ml of concentrated ammonia liquid were dissolved into 50 ml of de-ionized water to form a neutral liquid. The reactant liquid and the neutral liquid were current merged to completely hydrolyze the tin and antimony ions, and delivered by drops into 100 ml of water solvent prepared with HCl, pH 4. The solution was maintained at pH 4 and 45° C. until the reaction completed. The resulting precipitates were filtered and rinsed, then vacuum dried at 50° C. for 8 h, and ball milled. Following drying at 120° C. for 8 h and sintering at 850° C., ATO nanopowder of 10-80 nm in diameter was obtained. Hereinafter, the ATO nanopowder resulting from the conventional manufacturing method will be referred to as B1.

Microscopic observations revealed that A1 had a smaller average particle size and a more uniform particle size distribution (PSD), whereas B1 was found to be severely agglomerated over a particle size range of 10 nm to 80 nm. Based on experimental results, it is believed that the reactant concentration of B1 would need to be reduced by approximately 500% in order to match the diametric size and PSD of A1.

In order to compare the electrical conductivity of the ATO nanopowders, A1 and B1 were put into molds at room temperature and compressed at 200 kg/cm² to make cylinders of φ10^{mm}×2 mm. The diametric resistance measured for the cylinder pressed from A1 was R_{A}=0.3Ω. The diametric resistance measured for the cylinder pressed from B1 was R_{B}=5Ω. This value is over 16 times higher than that measured for the cylinder pressed from A1.

In a dispersibility test, 0.5 g each of A1 and B1 were poured into glass flasks containing 50 ml of ethanol. The flasks were ultrasonicated in an ultrasonic device for 30 minutes. After ultrasonication, large quantities of A1 remained suspended in the flask following a 24 h period, whereas large quantities of B1 sank to the bottom of the flask.

### EXAMPLE 2

This example sets forth a method for manufacturing nanoscale indium-tin oxide (ITO) particles according to the present invention, and further compares the same to nanoscale ITO particles prepared by a conventional method, which is also set forth below. In particular, the characteristics and properties, including particle size and particle size distribution, electrical conductivity and dispersibility, of the ITO nanopowders are compared in the following.

In a process corresponding to the inventive manufacturing method, 100 g of InCl₃, 11 g of SnCl₄.5H₂O and 1 g of ethylene acid were dissolved in 200 ml of isopropyl alcohol to prepare a reactant liquid. Separately, 100 ml of de-ionized water were mixed with 3 g of polyethylene ethanol to create a water solution. NaOH was used to maintain the pH of the water solution at pH=6. The reactant liquid was sent into the water solution at 45° C., and a co-precipitate of Sn(OH)₄ and In(OH)₃ was obtained by hydrolytic reaction. The co-precipitate was filtered, rinsed, and then dried at 120° C. for 8 h and sintered at 500° C. for 5 h. ITO nanopowder of 5-10 nm in size, hereinafter referred to as A2, was thereby produced.

In a process corresponding to a conventional manufacturing method, 100 g of SnCl₄.5H₂O, 12 g of InCl₃ and concentrated HCl were dissolved together into 200 ml of de-ionized water to make a reactant liquid. 50 ml of concentrated ammonia liquid were dissolved into 50 ml of de-ionized water to form a neutral liquid. The reactant liquid and the neutral liquid were current merged, and delivered by drops into 100 ml of water solvent prepared with HCl, pH 4. The solution was maintained at pH 4 and 45° C. until the reaction completed. The resulting precipitates were filtered and rinsed, then vacuum dried at 50° C. for 8 h, and ball milled. Followed drying at 120° C. for 8 h and sintering at 850° C., ITO nanopowder of 10-80 nm in size was obtained. Hereinafter, the ITO nanopowder resulting from the conventional manufacturing method will be referred to as B2.

Microscopic observations revealed that A2 had a smaller average particle size and a more uniform particle size distribution (PSD), whereas B2 was severely agglomerated over a particle size range of 10 nm to 80 nm. Based on experimental results, it is believed that the reactant concentration of B2 should be reduced by approximately 500% in order to match the diametric size and PSD of A2.

In order to compare the electrical conductivity of the ITO nanopowders, A2 and B2 were put into molds at room temperature and compressed at 200 kg/cm² to make cylinders of φ10^{mm}×2 mm. The diametric resistance measured for the cylinder pressed from A2 was R_{A}=0.3Ω. The diametric resistance measured for the cylinder pressed from B2 was R_{B}=5Ω. This value is over 16 times higher than that measured for the cylinder pressed from A2.

In a dispersibility test, 0.5 g each of A2 and B2 were poured into glass flasks containing 50 ml of ethanol. The flasks were ultrasonicated in an ultrasonic device for 30 minutes. After ultrasonication, large quantities of A2 remained suspended in the flask after 24 h, whereas large quantities of B2 sank to the bottom of the flask.

### EXAMPLE 3

This example sets forth a method for manufacturing nanoscale aluminum-zinc oxide (AZO) particles according to the present invention, and further compares the same to nanoscale AZO particles prepared by a conventional method, which is also set forth below. In particular, the characteristics and properties, including particle size and particle size distribution, electrical conductivity and dispersibility, of the AZO nanopowders are compared in the following.

In a process corresponding to the inventive manufacturing method, 136 g of ZnCl₂, 12.5 g of AlCl₃.6H₂O, and 1 g of ethylene acid were dissolved in 100 g of isopropylalcohol to prepare a reactant liquid. Separately, 100 ml of de-ionized water were mixed with 3 g of polyethylene ethanol to create a water solution. NaOH was used to maintain the pH of the water solution at pH 6. The reactant liquid was sent into the water solution at 45° C., and a co-precipitate of Zn(OH)₂ and Al(OH)₃ was obtained by a hydrolytic reaction. The product was filtered, rinsed, and then dried at 120° C. for 8 h and sintered at 500° C. for 5 h. AZO nanopowder of 5-10 nm in size, hereinafter referred to as A3, was thereby produced.

In a process corresponding to a conventional manufacturing method, 130 g of ZnCl₂, 12 g of AlCl₃.6H₂O and concentrated HCl were dissolved together into 200 ml of de-ionized water to make a reactant liquid. 50 ml of concentrated ammonia liquid were dissolved into 50 ml of de-ionized water to form a neutral liquid. The reactant liquid and the neutral liquid were current merged, and delivered by drops into 100 ml of water solvent prepared with HCl, pH 4. The solution was maintained at pH=4 and 45° C. until the reaction completed. The resulting precipitates were filtered and rinsed, then vacuum dried at 50° C. for 8 h, and ball milled. Followed drying at 120° C. for 8 h and sintering at 850° C., AZO nanopowder of 10-80 nm in diameter was obtained. Hereinafter, the nanoscale powder resulting from the conventional manufacturing method is referred to as B3.

Microscopic observations revealed that A3 had a smaller average particle size and a more uniform particle size distribution (PSD), whereas B3 was severely agglomerated over a particle size range of 10 nm to 80 nm. Experiments suggest that the reactant concentration of B3 should be reduced by approximately 500% in order to match the diametric size and PSD of A3.

In order to compare the electrical conductivity of the ATO nanopowders, A3 and B3 were put into molds at room temperature and compressed at 200 kg/cm² to make cylinders of φ10^{mm}×2 mm. The diametric resistance measured for the cylinder pressed from A3 was R_{A}=0.3Ω. The diametric resistance measured for the cylinder pressed from B3 was R_{B}=5Ω. This value is over 16 times higher than that measured for the cylinder pressed from A3.

In a dispersibility test, 0.5 g each of A3 and B3 were poured into glass flasks containing 50 ml of ethanol. The flasks were ultrasonicated in an ultrasonic device for 30 minutes. After ultrasonication, large quantities of A3 remained suspended in the flask after 24 h, whereas large quantities of B3 sank to the bottom of the flask.

### EXAMPLE 4

This example sets forth a method for consolidating the nanoscale metal oxide powder obtained by the inventive method into a sputtering target that may be used as a raw material for the deposition of a transparent conductive film.

Nanoscale powder, e.g., A1 (described in Example 1 above), is placed into a metal mold and compressed at an applied pressure of about 500 kg/cm², followed by compaction using a cold isostatic pressing (CIP) apparatus at an applied pressure of about 2 t/cm², thereby obtaining a partially densified compact. The compact is then transferred to an electric furnace and heated in air at about 1500° C. for approximately 5 h. The resulting high-density compact ITO is machined to the desired dimensions and attached to a backing plate by brazing, thereby obtaining a sputtering target.

### EXAMPLE 5

This example sets forth a method for forming the nanoscale metal oxide particles obtained by the inventive method into a dispersion that may be deposited onto a substrate to form a transparent conductive film.

Nanoscale particles prepared by the present method (e.g., A1 described in Example 1 above) are added to an aqueous solvent in an amount sufficient to make a dilute dispersion (e.g., about 20 wt. %). The dispersion undergoes a high-shear mixing and centrifuging process followed by collecting and filtering, in order to produce a concentrated dispersion. The dispersion is subsequently spin-coated or otherwise deposited onto the substrate of interest. The coated substrate is dried at a temperature above ambient to remove the solvent, and then heated to a temperature within the range of about 350° C. to about 800° C. to cure the particles in the deposited film, thereby obtaining a transparent conductive coating on the substrate.

Although the present invention has been described in considerable detail with reference to certain embodiments thereof, other embodiments are possible and are certainly contemplated to be within the present invention. The spirit and scope of the appended claims should not be limited, therefore, to the description of the preferred embodiments contained herein.

What is claimed:

1. A method of manufacturing nanoscale metal oxide particles comprising:
forming a first solution comprising one or more metal salts, an acid, and a solvent;
forming a second solution comprising an organic polymer, a base, and water;
combining the first solution and the second solution to form a combined solution, whereupon metal hydroxide particles precipitate out of the combined solution;
collecting, rinsing, and drying the metal hydroxide particles; and
heating the metal hydroxide particles, thereby forming nanoscale metal oxide particles.

2. The method of claim 1, wherein the one or more metal salts each comprise a metal ion selected from the group consisting of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, and Dy ions.

3. The method of claim 2, wherein the metal ion is selected from the group consisting of Al, In, Sb, Sn, and Zn ions.

4. The method of claim 1, wherein the acid is an organic acid.

5. The method of claim 4, wherein the organic acid comprises a monomer and a carboxylic acid.

6. The method of claim 5, wherein the organic acid is ethylene acid.

7. The method of claim 1, wherein the organic polymer is a vinyl polymer.

8. The method of claim 7, wherein the vinyl polymer is selected from the group consisting of polyethylene ethanol, polyvinylic alcohol (PVA), polyvinylpyrrolidinone (PVP), polyvinyl ether (PVE), and N-isopropylacrylamide (PNIPAAm).

9. The method of claim 8, wherein the organic polymer is polyethylene ethanol.

10. The method of claim 1, wherein collecting the metal hydroxide particles comprises a filtration step.

11. The method of claim 1, wherein the heating is carried out at a temperature that is at least about 400° C.

12. The method of claim 11, wherein the temperature is in the range of from about 400° C. to about 600° C.

13. The method of claim 1, wherein the heating is carried out for a duration that is at least about 4 hours long.

14. The method of claim 13, wherein the duration is in the range of from about 4 hours to about 6 hours.

15. The method of claim 1, wherein the nanoscale metal oxide particles are less than about 100 nanometers in size.

16. A method of manufacturing nanoscale metal oxide particles comprising:
forming a first solution comprising two or more metal salts, an acid, and a solvent;
forming a second solution comprising an organic polymer, a base, and water;
combining the first solution and the second solution to form a combined solution, whereupon metal hydroxide particles precipitate out of the combined solution;
collecting, rinsing, and drying the metal hydroxide particles; and
heating the metal hydroxide particles, thereby forming nanoscale metal oxide particles.

17. The method of claim 16, wherein the two or more metal salts each comprise a metal ion selected from the group consisting of Al, In, Sb, Sn, Zn, Ti, Zr, V, Nb, Cr, Mo, Mn, Fe, Co, Ni, Cu, Ag, Cd, Ga, Si, Ge, Pb, Bi, As, Se, Y, Eu, and Dy ions.

18. The method of claim 16, wherein the acid is an organic acid and the organic polymer is a vinyl polymer.

19. The method of claim 16, wherein the nanoscale metal oxide particles are less than about 100 nanometers in size.

20. A method of manufacturing nanoscale metal oxide particles comprising:
forming a first solution comprising two or more metal salts, ethylene acid, and a solvent;
forming a second solution comprising polyethylene ethanol, a base, and water;
combining the first solution and the second solution to form a combined solution, whereupon metal hydroxide particles precipitate out of the combined solution;
collecting, rinsing, and drying the metal hydroxide particles; and
heating the metal hydroxide particles at about 500° C. for about 5 hours, thereby forming nanoscale metal oxide particles.
